(19) United States
(12) Patent Application Publication
(10) Pub. No.: US 2004/0095223 A1
(43) Pub. Date: May 20, 2004

(54) Thermal overload relay

(75) Inventor: Kyung Ku Lee, Chungju-si (KR)

Correspondence Address: GREENBLUM & BERNSTEIN, P.L.C., 1950 ROLAND CLARKE PLACE, RESTON, VA, 20191, US

(73) Assignee: LG Industrial Systems Co., Ltd., Seoul (KR)

(21) Appl. No.: 10/694,877

(22) Filed: Oct. 29, 2003

(30) Foreign Application Priority Data
Nov. 15, 2002 (KR) 2002-71196

(51) Int. Cl. H01H 61/00; H01H 71/16

(52) U.S. Cl. 337/36

(57) ABSTRACT

A thermal overload relay comprises an actuating mechanism for generating power when an abnormal stat is occurred between a power source and an electrical load, and a switching mechanism for switching contacts on state or off state according to the power transferred from the actuating mechanism. The actuating mechanism includes a plurality of main bimetals arranged in parallel to the bottom surface of the case for being bended when the abnormal state is occurred; a plurality of heating member connected to the power source, each heating member is wound around the corresponding main bimetal for transferring heat occurred due to the abnormal state to the main bimetal; a shifter positioned to be contacted one ends of the main bimetals in parallel to the bottom surface of the case for being horizontally movable by the bending force of the main bimetals; and a lever connected to the shifter for transferring the movement force from the shifter to the switching mechanism.

### BACKGROUND OF THE INVENTION

(a) Field of the Invention

The present invention relates to a thermal overload relay for switching on or off a magnetic contactor connected thereto by using the bending characteristic of a main bimetal to be heated by a heating member, and more particularly to a thermal overload relay for reducing its size by horizontally installing main bimetals and heating members in an actuator against a horizontal plane, and safely being operated by modifying the construction of shifter and lever even though a phase deficiency is occurred.

(b) Description of the Related Art

In general, the thermal overload relay constitutes a magnetic switch together with the magnetic contactor, and serves as an electrical device for protecting an electrical load such as a motor from the overload or overcurrent generated when the current flowing through the motor exceeds a predetermined current value.

There is an AC motor as a typical electric load. For example, in three phases AC motor, three phases (R phase, S phase and T phase) AC current flows through the load. If any one of the 3 phases current is broken, current is concentrated on the other phases to cause overload. At this time, the insulation of the windings of the motor is broken or burned out due to the rise in temperature by overload or overcurrent.

Therefore the thermal overload relay is connected to the motor in order to protect the motor from the burning out by overload or phase deficiency.

The conventional thermal overload relay will be described in grater detail below with reference to FIGS. 1 and 2 of the accompanying drawings.

As shown in FIG. 1, the conventional thermal overload relay comprises an actuating part A and a switching part B.

The actuating part A is installed in a main case 1 to transfer power to the switching part B.

The switching part B is installed in an auxiliary case 5 for switching the magnetic contactor so that it is moved to “off state” position when an abnormal current is generated due to overload, phase deficiency, phase unbalance, phase inverting and so forth.

An adjusting dial 8 and a reset button 11 are also provided on the auxiliary case 5.

The adjusting dial 8 is a type of screw to be adjusted by a driver when a user wants to adjust an over current sensitivity of the overload relay. The reset button 11 is a type of push button to be adjusted by manually depressing it in downward direction when the user wants to return the overload relay to its original position after the circuit is cut off.

The construction and operation of the actuating part A and the switching part B of the conventional thermal overload relay will be described in grater detail below with reference to FIG. 2 of the accompanying drawings.

The actuating part A comprises a main case 1 for receiving main bimetals 2 (three main bimetals are provided if three phases AC motor is used), heating members 3 (corresponding to the number of the main bimetals), a pair of shifters 4 and 5, a lever (not shown), and so forth as principal components. The main bimetals 2 around which heating members 3 are wound are bended to a predetermined direction by the heat from the heating members 3 connected to the power source of the motor when an abnormal current is generated due to overload, phase deficiency, phase unbalance, negative phase sequence and so forth. Each of shifters 4a and 4b has a plate shape, is engaged with upper parts of the corresponding main bimetals 2, and is horizontally moved when the bimetals are bended. And the lever is rotatably connected to the shifters 4a and 4b.

The switching part B comprises a temperature compensation bimetal 6 contacted with the tip end of the lever of the actuating part A at its one end, for being rotatably operated together with the lever according to the horizontal movement of shifters 4a and 4b, a release lever 7 connected to the one end of the temperature compensation bimetal 6 for being rotated together with it when the temperature compensation bimetal 6 is rotated, and an inversion operation mechanism 10 switching a circuit contact to “on state” position or “off state” position when it is depressed by the release lever 7 according to the rotation of the release lever 7.

The inversion operation mechanism 10 comprises a contact provided at the one end thereof, two flat springs fixed to the other end thereof, and a coil spring connected to the flat springs. The inversion operation mechanism 10 is inversed from the bended state in the upper direction to the bended state in the lower direction, or from the bended state in the lower direction to the bended state in the upper direction when a certain pressure is applied thereto.

A stationary contact is installed at the position corresponding to the contact (movable contact) of the inversion operation mechanism 10. The movable contact of the inversion operation mechanism 10 and the stationary contact are normally open contacts in the normal state that current normally flows through the electrical load.

The inversion operation mechanism 10 is convexly bended from its center in the upper direction to make the contacts “off state” when user depresses the reset button 11 so as to return the overload relay to the original position after the circuit is cut off. Therefore, the signal supplied to the electromagnetic contactor is interrupted.

On the other hand, the other end of the inversion operation mechanism 10 opposite to the one end connected to the reset button 11 depresses the movable contact to be contacted with the stationary contact in the normal state that current normally flows through the electrical load, but pushes the reset button 11 according to the reversion operation of the inversion operation mechanism 10 in the abnormal state due to the overload and so forth.

Therefore the user may recognize whether the state of the circuit is normal or abnormal by observing the state of the reset button 11.

An adjustment link 9 is provided at the lower position of the adjustment dial 8 that is rotatably attached to the upper side of the auxiliary case 5. The adjustment link 9 is connected to the rotational shaft of the release lever 7 for adjusting the position of the rotational shaft of the release lever 7 by manipulating the adjustment dial 8.

According to the above-mentioned construction, when the circuit between the power source and the electrical load becomes to be abnormal state due to the overload, phase deficiency, and so forth, the heating member 3 lo generates heat by current supplied from the power source, and the heat is transferred to the main bimetal 2. The main bimetal 2 is bended to the rightward direction in FIG. 1 by the heat supplied from the heating member 3, thereby pushing the shifters 4a and 4b to the rightward direction.

When the shifters 4a and 4b are pushed to the right direction in the state that they are contacted to the free end of the temperature compensation bimetal 6, the temperature compensation bimetal 6 is rotated in the counter clockwise direction. The release lever 7 is rotated in counter clockwise direction by the bending of the main bimetal 2 since the temperature compensation bimetal 6 is connected to the end of the release lever 7.

As above-mentioned, when the release lever 7 is rotated around the rotational shaft, the inversion operation mechanism contacted with the release lever 7 is depressed by the release lever 7 to perform reversion operation.

Therefore the normally close contact is moved from the close stated to the open state and the normally open contact is moved from the open state to the close state, thereby generating a signal that switches the magnetic contactor to the position maintaining “off state” of the circuit. As a result, it is possible to prevent the motor from burning out since the power supplied by the magnetic contactor is not supplied to the motor to protect the motor from the overcurrent or current concentration phenomenon that current is concentrated on any one phase.

If the user wants to return the inversion operation mechanism 10 to the original position after it is reversed to the upper direction, the user simply depresses the reset button 11 provided on the auxiliary case 5. And then the end of the inversion operation mechanism 10 is moved to the downward direction, thus the normally open contact is returned to the original position of separation state.

On the other hand, if the user wants to change a trip current value set in initial value, the user may adjust the desired trip current value by manipulating the adjustment dial 9 so that the position of the rotational shaft of the release lever 7 is adjusted.

However it is difficult to reduce the height of the case 1 to a desired extent since the above-mentioned conventional thermal overload relay is constructed that the main bimetals 2 and the heating members 3 of the actuating part A are formed vertically in perpendicular to the bottom surface of the main case 1. Therefore it is impossible to manufacture a compact overload relay, and also construct a compact magnetic switch in combination of compact magnetic contactor.

Also, the convention thermal overload relay often failed to cut off the circuit even though phase deficiency is generated, because the shifters 4a and 4b are consisted of two plate members and have the construction that they are horizontally movable in cooperation with the three main bimetals 3, and thus the displacement of the horizontal movement is too small to make stably contacts open state or close state when one phase is or two phases are in deficiency.

### SUMMARY OF THE INVENTION

It is an object of the present invention to overcome the problems of the conventional art structure, thus to provide a thermal overload relay for reducing its size, that is, the height of main case by horizontally installing main bimetals and heating members against a horizontal plane.

It is another object of the present invention to provide a thermal overload relay for safely operating by modifying the construction of shifter and lever even though a phase deficiency is occurred.

The forgoing and the other objects of the present invention have been attained by providing a thermal overload relay comprising an actuating mechanism for generating power when an abnormal stat is occurred between a power source and an electrical load; a switching mechanism for switching contacts on state or off state according to the power transferred from the actuating mechanism; and a case for receiving the actuating mechanism and the switching mechanism, wherein the actuating mechanism including: a plurality of main bimetals arranged in parallel to the bottom surface of the case for being bended when the abnormal state is occurred; a plurality of heating member connected to the power source, each heating member is wound around the corresponding main bimetal for transferring heat occurred due to the abnormal state to the main bimetal; a shifter positioned to be contacted one ends of the main bimetals in parallel to the bottom surface of the case for being horizontally movable by the bending force of the main bimetals; and a lever connected to the shifter for transferring the movement force from the shifter to the switching mechanism.

In the above construction, the shifter consists of an upper shifter and lower shifter so that they are positioned in upper and lower sides to each other, each shifter is arranged in substantially perpendicular to the one end of the main bimetal, and in parallel to the bottom surface of the case.

Also, the shifter further comprises a pair of shaft for connecting the lever to the upper shifter and the lower shifter respectively, so as to transfer the displacement amount generated by the bending force of the main bimetals to the switching mechanism.

### RIEF DESCRIPTION OF THE DRAWINGS

The accompanying drawings, which are incorporated in and constitute a part of the specification, illustrate an embodiment of the invention, and together with the description, serve to explain the principles of the invention.

FIG. 1 is a perspective view of a conventional thermal overload relay; FIG. 2 is a cross-sectional view of the convention thermal overload relay shown in FIG. 1;

FIG. 3 is a perspective view of an embodiment of the thermal overload relay according to the present invention;

FIG. 4 is a cross-sectional view of the thermal overload relay according to the present invention shown in FIG. 3;

FIG. 5 is a perspective view of the actuating part of the thermal overload relay according to the present invention; and

FIGS. 6A to 6C are drawings for illustrating operation states of shifters of the thermal overload relay according to the present invention.

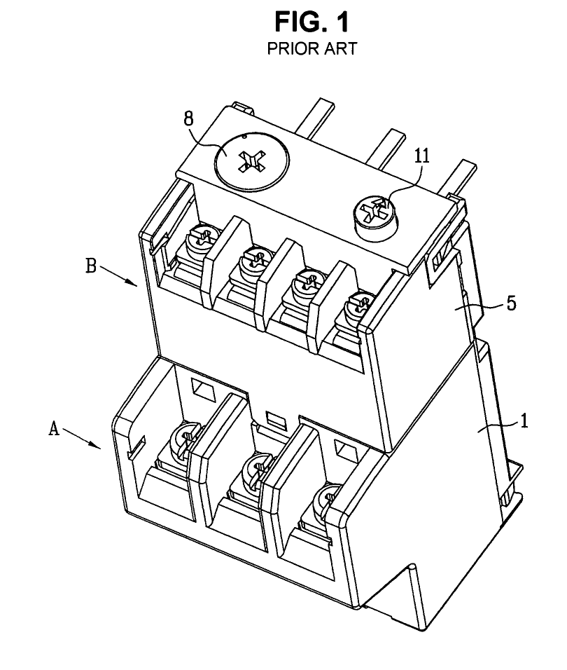

### DETAILED DESCRIPTION OF THE PREFERRED EMBODIMENTS

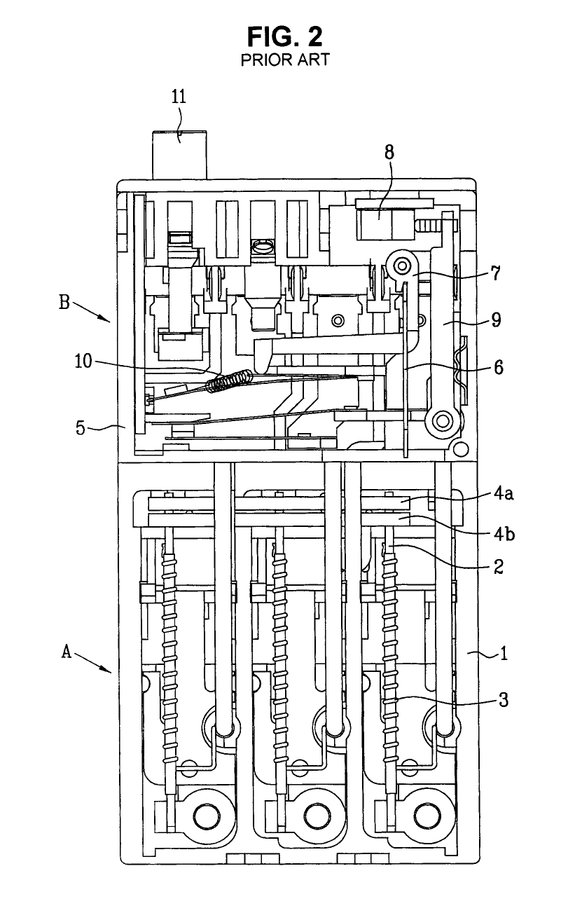

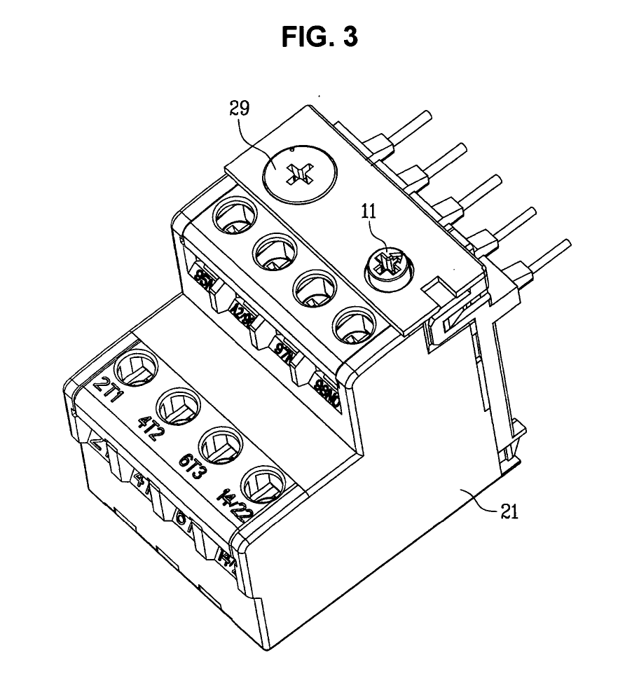

A preferred embodiment of the present invention will be described hereinafter with reference to FIGS. 3 to 6 of the accompanying drawings.

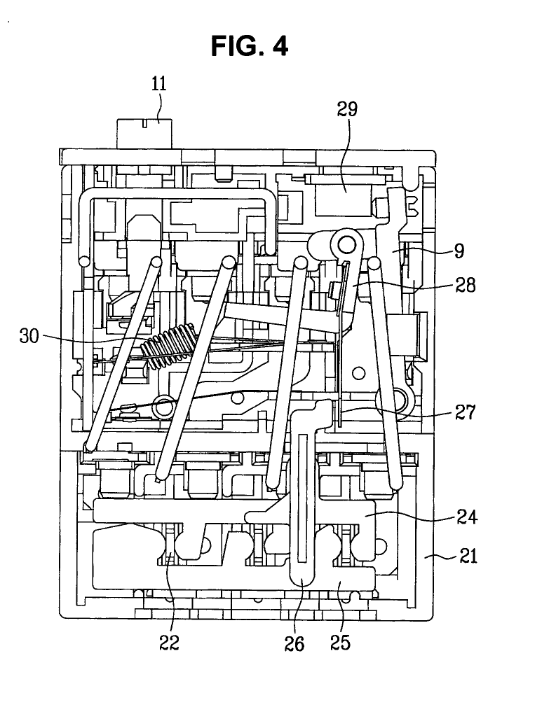

FIG. 4 shows a cross-sectional view of an embodiment of the thermal overload relay according to the present invention.

The thermal overload relay according to the present invention comprises an actuating part for generating power by abnormal state generated between a power source and an electrical load due to overload, phase deficiency, phase unbalance, phase inverting and so forth, and a switching part for switching contacts open or close state by the power from the actuating part. The thermal overload relay according to the present invention is similar to the conventional thermal overload relay, except that the height of the actuating part is formed lower than that of the conventional thermal overload relay and the actuating part and the switching part are assembled into one case 21.

The actuating part comprises main bimetals 22 around which heating members 23 are wound, the main bimetals 22 are bended to a predetermined direction by the heat from the heating members 3 connected to the power source of the motor when an abnormal current is generated due to overload, phase deficiency, phase unbalance, phase inverting and so forth.

And in case that the thermal overload relay according to the present invention is used with the magnetic contactor so as to protect a three-phases AC motor at the time of the generation of abnormal state, the number of main bimetals 22 provided in the actuating part is three so that each main bimetal is corresponding to each phase current of the three phases. And also the number of the heating members 23 is three so that each heating member is wound around the corresponding main bimetal.

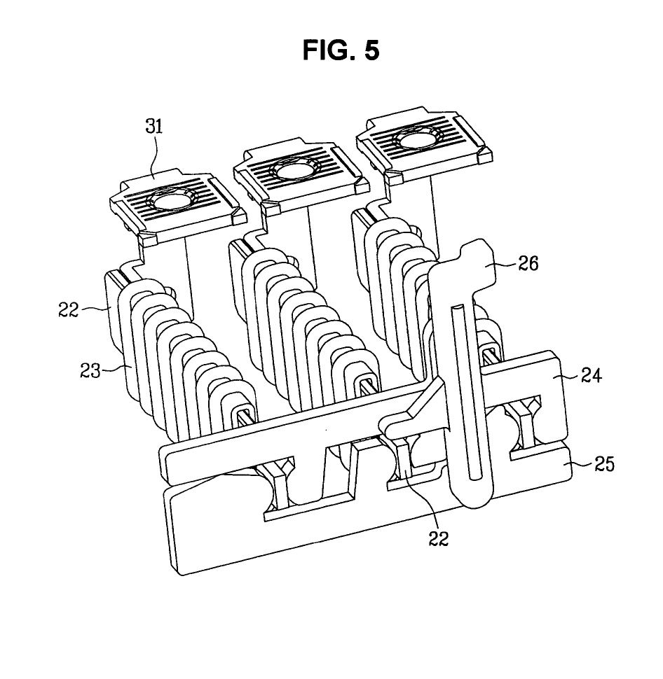

FIG. 5 shows the actuating part of the thermal overload relay according to the present invention.

The construction of main bimetals 22 and heating members 23 will be described in greater detailed below with reference to FIG. 5.

As shown in FIG. 5, an upper shifter 24 and lower shifter 25 are installed horizontally, in parallel and on a vertical plane against the bottom surface of the case 21. A lever 26 is connected to the upper shifter 24 and lower shifter 25 by shafts or pins (not shown). Therefore the lever 26 is pivoted around the shafts when the shifters 24 and 25 are moved to horizontal direction.

The upper shifter 24 comprises an elongated flat portion, and a plurality of extension portion extended in the downward direction from the flat portion to be contacted with the free ends of main bimetals 22. And also the lower shifter 25 comprises an elongated flat portion, and a plurality of extension portion extended in the upward direction from the flat portion to be contacted with the free ends of main bimetals 22. The extension portions are arranged in a determined direction. Each free end is positioned between the extension portion of the upper shifter 24 and the extension portion of the upper shifter 25.

Therefore all three main bimetals are bended by the heat from the heating members 23 when overcurrent flows into circuit. However the other bimetals except the bimetal corresponding to phase deficiency are bended if phase deficiency is generated in any one of three phases. And then the upper shifter 24 and the lower shifter 25 contacted with the free ends of main bimetals are horizontally moved according to the bending displacement of main bimetals.

The switching part comprises a temperature compensation bimetal 27 contacted with the tip end of the lever 26 for being rotatably operated according to the rotational operation of the lever 26, a release lever 28 fixedly connected to the one end of the temperature compensation bimetal 27 for being rotated together with it, and being rotated around the shaft supported by the case 2, and an inversion operation mechanism 30 switching a circuit contact to “on state” position or “off state” position according to the rotation of the release lever 28.

The temperature compensation bimetal 27 is substantially arranged perpendicular to the main bimetals 22.

The inversion operation mechanism 30 comprises a contact (that is, movable contact) provided at its one end, two flat springs fixed to its the other end, and a coil spring connected to the flat springs. The inversion operation mechanism 30 is inversed from the bended state in the upper direction to the bended state in the lower direction or from the bended state in the lower in the bended state in the upper direction when the pressure more than a predetermined pressure is applied to the center of the longitudinal direction.

A stationary contact is installed at the position corresponding to the movable contact of the inversion operation mechanism 30. The movable contact of the inversion operation mechanism 30 and the stationary contact are normal open contacts in the normal state that current normally flows through the electrical load.

The one end of the inversion operation mechanism 30 is connected to the reset button 11 by a link mechanism. The flat spring of the inversion operation mechanism 30 is convexly bended from its center to the upper direction when the user depresses the reset button 11 so as to return the overload relay to the original position after the circuit is cut off. Therefore, the movable contact and the stationary contact are separated from each other, and the signal supplied to the magnetic contactor is interrupted.

On the other hand, the other end of the inversion operation mechanism 30 depresses the movable contact to be contacted with the stationary contact in the normal state that current normally flows through the electrical load. But the link mechanism pushes the reset button 11 upward according to the reversion of the inversion operation mechanism 30 in the abnormal state due to the overload and so forth. Therefore the movable contact is separated from the stationary contact.

Therefore the user may recognize whether the state of the circuit is normal or abnormal by observing the state of the reset button 11.

An adjustment link 9 is provided at the lower position of the adjustment dial 29 which is rotatably engaged with the upper side of the case 21. The adjustment link 9 is connected to the rotational shaft of the release lever 28 for adjusting the position of the rotational shaft of the release lever 28 by manipulating the adjustment dial 29.

The construction of the actuating mechanism according to the present invention will be described in greater detail below with reference to FIG. 5.

As above-mentioned, the number of the main bimetal is determined according to the number of phase to be used. In this embodiment, the number of the main bimetal is three since three phases current is used. The three main bimetals 22 are in parallel arranged in a predetermined distance so that its width direction is upward. Also each heating member 23 is wound around the corresponding to the main bimetal 22. Each heating member 23 transfers heat to the corresponding main bimetal 22 when abnormal state is occurred between the power source and the electric load due to overload and so forth.

Each heating member 23 is connected to each corresponding terminal 31 which is connected to the electric load such as three phases AC motor by a conducting line (not shown).

As shown in FIG. 5, the ends of the main bimetals opposite to the terminals 31 are arranged so that the ends are contacted with the upper shifter 24 and the lower shifter 25, respectively.

As above-mentioned, the upper shifter 24 comprises the elongated flat portion, and a plurality of extension portion downward extended from the flat portion in a predetermined distance. Also, the lower shifter 25 comprises the elongated flat portion, and a plurality of extension portion upward extended from the flat portion in a predetermined distance. The upper shifter and the lower shifter are arranged so that its free end is positioned between the extension portions of the upper shifter and the extension portion of the lower shifter.

As thus, the upper shifter 24 and the lower shifter 25 are arranged so that they can be operated in interlocking with the movement of the main bimetals 22.

The lever 26 is engaged with the flat portions of the upper and lower shifters 24 and 25 by shafts or pins (not shown). Therefore the lever 26 is horizontally movable or rotatable in interlocking with the operation of the shifters 24 and 25.

The operation of the thermal overload relay according to the present invention will be described in greater detail below with reference to FIGS. 4 to 6.

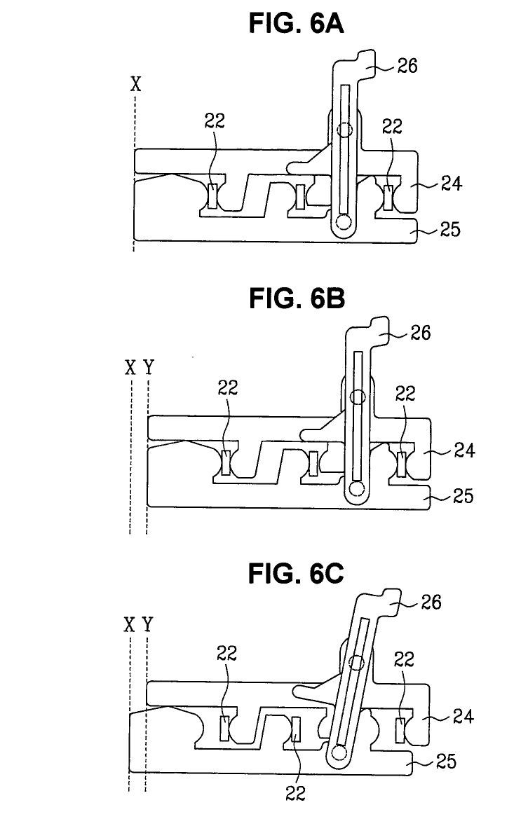

In the normal state that normal current flows through the circuit between the power source and the electric load, the main bimetals 22 in not bended. Thus the left ends of the shifters 24 and 25 are positioned at X position as shown in FIG. 6A.

At the initial state as this, if overcurrent flows through the circuit due to overload, the three heating members 23 generates heat and transfer the heat to the main bimetals 22. And then the main bimetals 22 are bended in the rightward direction by the heat. The free ends of the bimetals 22 are moved to rightward direction by the bending force. As a result, the shifters 24 and 25 are also horizontally moved by the free ends of the main bimetals. At this time, the position of the left ends of the shifters 24 and 25 are moved to position Y, the lever 26 connected to the shifters 24 and 25 by shafts or pins is also horizontally moved corresponding to the displacement distance of the shifters 24 and 25.

As above-mentioned, when the lever 26 is moved, the temperature compensation bimetal 27 is rotated in counter clockwise direction, and thus the release lever 28 is rotated in counter clockwise direction, thereby depressing the inversion operation mechanism 30 downward.

Therefore the normally close contact is changed from close state to open state, and the normally open contact is changed from open state to close state. And then the signal switching the magnetic contactor off is supplied to the magnetic contactor, thereby preventing overcurrent from flowing through the motor. As a result, it is possible to protect the motor from burning out by overload, and so forth.

In the abnormal state that phase deficiency is occurred in one or two of three phases, for example in case that the phase deficiency is occurred in the middle phase, both of the left bimetal and the right bimetal are bended in the rightward direction since the middle heating member of three heating members does not generate heat, and the left heating member and the right heating member generate heat. Therefore lower shifter 25 is stationary to maintain the initial position X, and the upper shifter 24 is moved to Y position as shown in FIG. 6C. That is, the position of the left end of the lower shifter 25 is positioned at X, the position of the left end of the upper shifter 24 is positioned at Y.

The upper portion of the lever 26 is horizontally moved in the rightward direction since the lever 26 is connected to the shifters 24 and 25. Accordingly the temperature compensation bimetal 27 is rotated in the counter clockwise direction by the rotational force of the lever 26.

At this time, the release lever 28 is rotated in the counter clockwise. And then the inversion operation mechanism 30 performs the reversed movement since the inversion operation mechanism contacted with the release lever 28 is depressed in the downward by the release lever 28.

Therefore the normally close contact is changed from close state to open state, and the normally open contact is changed from open state to close state. And then the signal switching the magnetic contactor off is supplied to the magnetic contactor, thereby preventing overcurrent from flowing through the motor. As a result, it is possible to protect the motor from burning out by overload, and so forth.

As above-mentioned, the lever 26 of the thermal overload relay according to the present invention is engage with the flat portions of the shifters 24 and 25 by shafts or pins shown as dot circles in FIG. 6C. Therefore it is possible to accurately perform the switching operation of the contactor since the upper shifter 24 is horizontally moved to rotate the lever 26 even though the lower shifter 25 is in the stationary state due to the phase deficiency. As a result, the thermal overload relay according to the present invention safely protects the electrical load from the damage since the signal switching the electromagnetic contactor off is correctly transmitted thereto.

Also, if the user wants to return the position of the inversion operation mechanism 30 to the original position after the inversion operation mechanism 30 performs the reversed movement, the user may depress the reset button 11. And then the end of the inversion operation mechanism 30 is moved in the downward direction, thereby returning the normally open contact to the original position in the open state.

On the other hand, if the user wants to change the trip current value set in initial value, the user may adjust the desired trip current value by manipulating the adjustment dial 29 so that the position of the rotational shaft of the release lever 28 is adjusted.

According to the above-mentioned construction, it is possible to provide a thermal overload relay for reducing its size, that is, the height of main case by horizontally positioning the main bimetals and the heating members against the bottom surface of the main case. Therefore it is possible to manufacture a compact the thermal overload relay, and further manufacture a compact switching apparatus by combining the thermal overload relay with the magnetic contactor.

Also, it is possible to provide a thermal overload relay for safely operating at an occurrence of phase deficiency by modifying the construction of shifter and lever so that a pair of shifters are arranged in the upper and lower sides, and connecting the shifters to the lever by shafts or pins, thereby accurately rotating the temperature compensation bimetal in interlocking with the rotation of the lever even though the phase deficiency is generated the circuit. Therefore it is possible to accurately control the operation of the thermal overload relay according to the present invention in comparison with the conventional thermal overload relay, and then safely protect the motor from the burning out due to the phase deficiency.

What is claimed is:

1. A thermal overload relay comprising:
an actuating mechanism for generating power when an abnormal state is occurred in a circuit between a power source and an electrical load;
a switching mechanism for switching contacts on state or off state according to the power transferred from the actuating mechanism; and
a case for receiving the actuating mechanism and the switching mechanism;
wherein the actuating mechanism including:
a plurality of main bimetals arranged in parallel to the bottom surface of the case for being bended when the abnormal state is occurred;
a plurality of heating member, each of the heating member is wound around the corresponding main bimetal for transferring heat occurred due to the abnormal state to the main bimetal;
a shifter positioned to be contacted one ends of the main bimetals in parallel to the bottom surface of the case for being horizontally movable by the bending force of the main bimetals; and
a lever connected to the shifter for transferring the movement force from the shifter to the switching mechanism.

2. The thermal overload relay according to claim 1, wherein the shifter comprising an upper shifter and lower shifter so that they are positioned on a vertical plane, each shifter is arranged in substantially perpendicular to the one end of the main bimetal, and in parallel to the bottom surface of the case.

3. The thermal overload relay according to claim 1, wherein the shifter comprising an upper shifter and lower shifter so that they are positioned on a vertical plane, each shifter is arranged in substantially perpendicular to the one end of the main bimetal, and in parallel to the bottom surface of the case, and the shifter further comprising a pair of shaft for connecting the lever to the upper shifter and the lower shifter respectively, so as to transfer the displacement amount generated by the bending force of the main bimetals to the switching mechanism.
